(19) United States
(12) Patent Application Publication
(10) Pub. No.: US 2005/0053381 A1
(43) Pub. Date: Mar. 10, 2005

(54) Repeater node and serial bus system therefor

(75) Inventor: Stephen R. Wood, Benbrook, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Lockheed Martin Corporation, Bethesda, MD (US)

(21) Appl. No.: 10/639,097

(22) Filed: Aug. 12, 2003

(51) Int. Cl. H04B 10/00

(52) U.S. Cl. 398/140

(57) ABSTRACT

A repeater node for a serial bus system is provided. The repeater node comprises an optic receiver adapted to receive an optic signal supplied thereto. An optic-to-electrical conversion circuit converts the optic signal into a corresponding electrical signal that is output from a transmitter. A switching mechanism is coupled with the transmitter and is adapted to electrically decouple the transmitter from an electrical transmission medium in the absence of the optic signal. A cable serial bus system including a first node comprising a physical layer and a port adapted to receive an electrical signal supplied thereto is provided. A switching mechanism is adapted to couple a transmitter and the port. A transmission medium couples the switching mechanism and the port. The system is adapted to decouple the transmitter from the port in absence of an optic signal at a receiver.

This invention was made with Government support under Contract Number N00019-02-C-3002 awarded by The Department of the Navy. The Government has certain rights in this invention.

### TECHNICAL FIELD OF THE INVENTION

This invention relates to network technologies and, more particularly, to a system and method for converting a 1394b serial bus signal to a fiber optic signal without an addressable bus node.

### BACKGROUND OF THE INVENTION

A high speed serial bus for asynchronous and isochronous data transfers between a computer and peripheral devices is standardized by the 1394b serial bus standard. The standardization of the 1394b serial bus has been widely accepted and has provided performance improvements for data intensive peripheral devices and services. In particular, the 1394b standard provides for bus node interfaces with fiber optic media. However, a number of deficiencies relating to the 1394b standard exist. For example, the number of bus nodes through which a transaction may take place is limited to a maximum hop count. Moreover, the inter-nodal distance is limited. For adjacent bus nodes separated by a large distance, bus nodes configured as repeaters are often deployed. A conventional bus node configured as a repeater requires a bus node address thereby consuming otherwise available bus infrastructure capacity. Additionally, it is sometimes desirable to implement a serial bus in accordance with the 1394b standard using only electrical transmission media. In some cases, prototyping and testing of the serial bus is not possible on purely electrical transmission media due to bus prototype peripheral localities. In such a case, it is desirable to deploy repeaters in a bus prototype such that bus node addresses and transmission hops of the bus prototype accurately model the design bus that will exclude the repeater.

### SUMMARY OF THE INVENTION

Heretofore, a technique for converting a 1394b serial bus signal to a fiber optic signal without the use of an addressable 1394b bus node has not been provided. In accordance with an embodiment of the present invention, a repeater node for a serial bus system is provided. The repeater node comprises an optic receiver adapted to receive an optic signal supplied thereto. An optic-to-electrical conversion circuit converts the optic signal into a corresponding electrical signal that is output from a transmitter. A switching mechanism is coupled with the transmitter and is adapted to electrically decouple the transmitter from an electrical transmission medium in the absence of the optic signal.

In accordance with another embodiment of the present invention, a cable serial bus system including a first node comprising a physical layer and a port adapted to receive an electrical signal supplied thereto is provided. A first fiber optic transceiver is adapted to convert an optic signal into the electrical signal and comprises a transmitter adapted to output the electrical signal. A switching mechanism is adapted to couple the transmitter and the port. A transmission medium couples the switching mechanism and the port. The system is adapted to decouple the transmitter from the port in the absence of the optic signal.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a serial bus system implemented in accordance with the 1394b serial bus standard and that may have a repeater deployed therein according to embodiments of the invention;

FIG. 2 is a simplified schematic of a physical layer comprising various logic blocks as may be implemented in a node of the serial bus system described with reference to FIG. 1;

FIG. 3A is a block diagram of nodes interconnected by a transmission medium;

FIG. 3B illustrates a sequence of connection tones that facilitate connection detection between the nodes described with reference to FIG. 3A;

FIG. 3C shows available tone positions in a speed code tone pattern for negotiating transmission speeds between the nodes described with reference to FIG. 3A;

FIG. 4 is a simplified schematic of a repeater node connecting the nodes described with reference to FIG. 3A;

FIG. 5A is a block diagram of a transceiver that may be implemented as a repeater in a serial bus system in accordance with embodiments of the invention

FIG. 5B is an illustrative voltage waveform output by a transmitter circuit of the transceiver described with reference to FIG. 5A;

FIG. 6 is a simplified schematic of a fiber optic transceiver as implemented in a repeater node in accordance with embodiments of the invention;

FIG. 7 is a block diagram of a repeater configuration comprising two transceiver nodes in accordance with embodiments of the invention; and

FIG. 8 an exemplary repeater node fabricated from commonly available electrical components as implemented in the repeater configuration of FIG. 7 in accordance with embodiments of the invention.

### DETAILED DESCRIPTION OF THE DRAWINGS

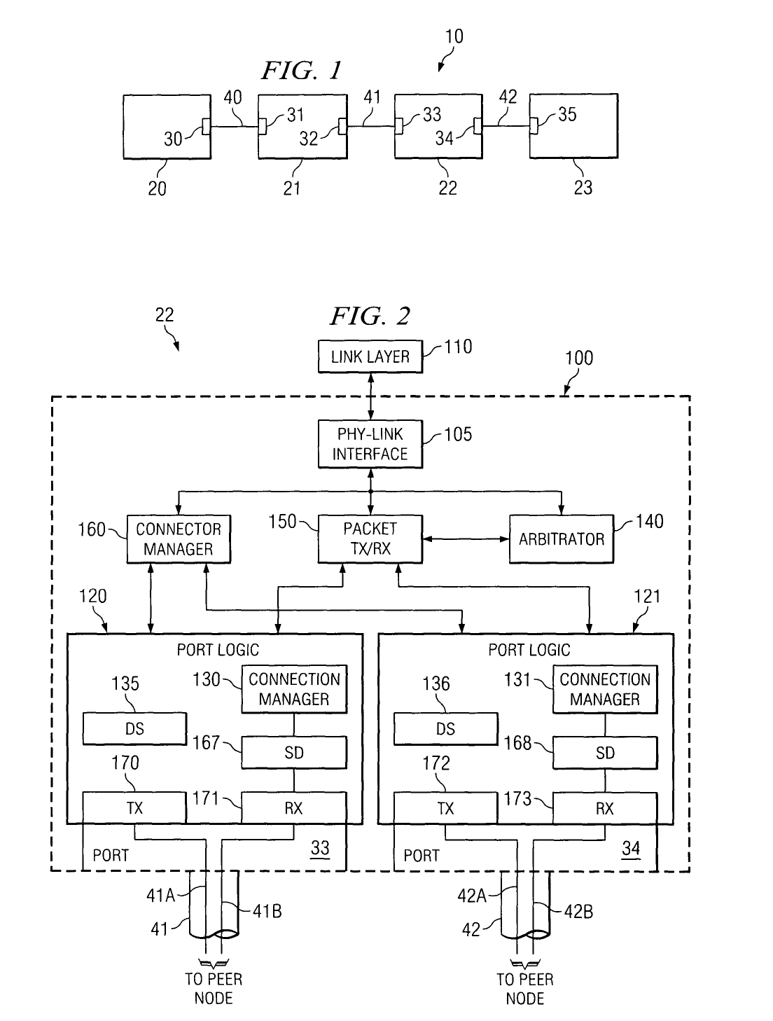

The preferred embodiment of the present invention and its advantages are best understood by referring to FIGS. 1 through 8 of the drawings, like numerals being used for like and corresponding parts of the various drawings.

FIG. 1 is a simplified block diagram of a serial bus system 10 implemented in accordance with the Institute for Electrical and Electronics Engineers (IEEE) 1394b serial bus standard and that may have a repeater deployed therein according to embodiments of the invention. Exemplary system 10 comprises a plurality of nodes 20-23 configured in a daisy chain manner. Adjacent nodes are interconnected by a physical connection that comprises a port at each node terminating a cable interconnected therebetween. The physical connection is a full-duplex communication channel comprising a pair or communication links, e.g., two twisted pair electrical transmission mediums or two optic fibers. For example, peer nodes 22 and 23 have a physical connection comprising a transmission medium 42 having two copper twisted pairs terminated by respective ports 34 and 35 for establishing two simplex communication paths therebetween. System 10 topology is limited by latency requirements that define maximum round-trip periods as required for the arbitration control procedure defined by IEEE 1394b. A maximum hop count that is monitored by the bus management system limits the number of addressable nodes that can be included in a daisy chained serial bus system 10. A serial bus node may comprise more than two ports and IEEE 1394b provides for branched node interconnects for increasing the number of nodes that may be deployed in a serial bus system. However, the number of addressable nodes and hops is limited by the bus management system.

FIG. 2 is a simplified block diagram of a physical (PHY) layer 100 comprising various logic blocks as may be implemented in a node, e.g., node 22, of serial bus system 10. Each of nodes 20-21 and 23 in bus system 10 is equipped with a PHY layer similar to PHY layer 100. PHY layer 100 comprises a PHY-Link Interface 105 for communicating with a client application by way of a link layer 110 that interfaces with a host adapter. PHY layer 100 comprises one or more port logic 120 and 121 blocks. Port logic 120 and 121 comprise respective electrical transmitter (TX) 170 and 172 and receiver (RX) 171 and 173 circuits and associated logic that provide transmit and receive functions for suitably formatting data for transmission over a transmission medium 41 and 42 and receiving data therefrom. Port logic 120 and 121 comprise connection management logic 130 and 131 and data strobe logic 135 and 136. In the illustrative example, transmission mediums 41 and 42 comprise a respective electrical transmission medium, e.g., copper twisted pairs 41A-41B and 42A-42B, although other transmission mediums, e.g., a plastic or glass optic fiber, may be accommodated by PHY layer 100. Accordingly, port logic 120 and 121 comprise electrical transceivers and requisite logic and circuitry for interfacing with electrical transmission mediums 41 and 42. Port connection manager 130 and 131 detects the presence of a peer port respectively connected to transmission medium 41 and 42 and facilitates speed negotiation therewith. As referred to herein, a port refers to both a physical transmission medium interface and the associated port logic unless otherwise specified.

A physical connection between, for example, nodes 22 and 23 is established over transmission medium 42 and comprises a full-duplex communication path between port 34 of node 22 and a port 35 of node 23. The physical connection is comprised of two simplex physical links established between nodes 22 and 23. A simplex physical link is terminated by TX 172 of node 22 and an RX of node 23 and another simplex physical link is terminated by RX 173 of node 22 and a TX of node 23. In the illustrative example, twisted pair 42A is coupled with TX 172 of node 22 and terminates at an RX of node 23 for establishment of a simplex physical link from node 22 and 23. Likewise, twisted pair 42B is electrically coupled with RX 173 of port 34 and terminates at a TX of node 23 for establishing a simplex physical link for data transmissions from node 23 to node 22. A signal detect circuit (SD) 167 and 168 is respectively coupled with RX 171 and 173 and is adapted to detect an electrical signal applied to ports 33 and 34.

An arbitrator 140 performs input/output (I/O) control and bus arbitration among nodes interconnected in system 10 that vie for ownership of the bus as specified in the IEEE 1394b standard. In general, an arbitration request conveyed to PHY layer 100 via link layer 110 is processed by arbitrator 140. An arbitration request is transmitted over the cable bus system to a parent node. Upon assignment of control of the bus to PHY layer 100, data may be transmitted from PHY layer 100 across the bus system via transmission mediums 41 and 42. A packet transmit and receive buffer 150 is communicatively coupled with link layer 110 and port logic 120 and 121 and functions to temporarily store data to be transmitted from PHY layer 100 to a peer node and data received from a peer node that is to be conveyed to an upper layer, e.g., an application layer via link layer 110.

A node connection manager 160 performs node connection functions in conjunction with port connection managers 130 and 131 and signal detect circuits 167 and 168. In general, port connection managers 130 and 131 process the detection of a peer port and establish a suitable signaling speed with an associated peer node. Node connection manager 160 maintains configuration data regarding the status of node 22 within bus system 10 and connection information of other node ports within the bus system. Additionally, connection manager 160 maintains port arbitration status, data transmission, reception and repeat behaviors as is known.

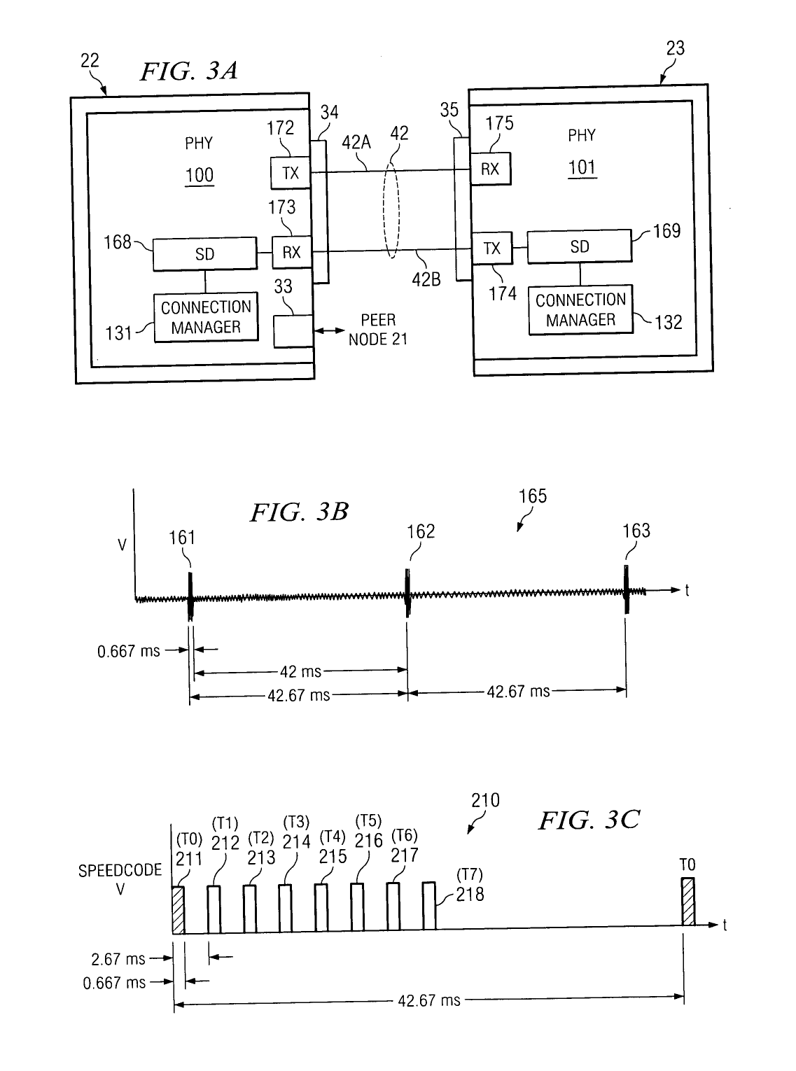

With reference to FIG. 3A, there is shown a block diagram of nodes 22 and 23 interconnected by transmission medium 42. Transmission medium 42 comprises twisted pair 42A interconnected with TX 172 of port 34 and an electrical RX 175 of port 35 and twisted pair 42B interconnected with RX 173 of port 34 and an electrical TX 174 of port 35. Prior to transmitting data between nodes 22 and 23, a connection detection routine is performed by PHY layer 100 and a PHY layer 101 of node 23. In general, port connection between PHY layers 100 and 101 is facilitated by intermittent transmission of a tone over a physical connection between interconnected ports 34 and 35. A tone signal is periodically applied to a transmit circuit and when a peer node is connected to the link, the tone signal is received by a signal detect circuit of the destination port.

FIG. 3B illustrates a sequence 165 of connection tones 161-163 that facilitate connection detection between nodes 22 and 23. In the illustrative example, assume tones 161-163 are transmitted from node 23 to node 22 via twisted pair 42B. TX 174 applies connection tones 161-163 to twisted pair 42B under direction of a port connection manager 132. Connection tones 161-163 comprise a constant frequency, e.g., 48 to 61 MHz, transmission of a predefined duration, e.g., 0.667 ms. In accordance with the IEEE 1394b standard, each tone 161-163 is followed by a signal silence interval of approximately 42 ms. Signal detect circuit 168 detects one or more of connection tones 161-163 at RX 173. Notably, signal detect circuit 168 relies on the intervening silent interval between subsequently transmitted connection tones to accurately evaluate a connection tone. Upon detection of a connection tone, the signal detect circuit supplies a signal detect indication to connection manager 131. It is understood that a similar procedure is performed by node 22 transmitting connection tones to node 23.

A speed negotiation procedure commences upon completion of connection detection between peer nodes 22 and 23. Speed negotiation is performed by each node transmitting a tone pattern 210 indicating the respective node's speed capability, e.g., S200, S400, etc. FIG. 3C shows available tone positions (T0-T7) in speed code tone pattern 210 for negotiating transmission speeds between peer nodes 22 and 23 in accordance with the IEEE 1394b standard. The exemplary speed code pattern comprises eight possible tone positions. A first tone 211 of each speed code is asserted. An acknowledge (ACK) tone 212 comprises an acknowledgement bit and is asserted only upon completion of a successful speed negotiation. The speed capacity of each node is indicated by the presence of absence of tones 213-215 in tone positions T2-T4. Table 1 summarizes the tone position values for port speed capacity as designated by the IEEE 1394b standard where logic 1 designates assertion of a tone and logic 0 indicates tone absence. Tone positions T5 and T6 are utilized for indication of configuration data of the particular PHY layer and may be asserted or non-asserted dependent on the particular PHY layer capabilities. In general, each tone included in tone pattern 210 comprises a constant frequency burst, e.g., a 48 to 61 MHz transmission, of a predefined duration, e.g., 0.667 ms, and consecutive tone positions are separated by 2 ms of required signal silence. Successive speed code sequences are separated by a sequence code spacing, e.g., 42.67 ms. Signal detect circuit 168 comprises logic for interpreting a received speed code and conveys the detected speed code to connection manager 130. Upon successful negotiation of a transmission speed between nodes 22 and 23, a speed code sequence is exchanged between peer nodes for the negotiated speed along with the acknowledge tone. Upon receipt of a speed code with an acknowledge tone, transmission of the speed code sequence is terminated and the connection between peer nodes 22 and 23 is established. Node connection manager 160 maintains negotiated speed parameters and data transactions between nodes 22 and 23 are facilitated thereby. Similar to evaluation of connection detect signaling, signal detect circuit 168 relies on the signal silence intervals between consecutive tones for evaluation of received speed code pattern 210.

TABLE 1

| Speed | T0 | T1 | T2 | T3 | T4 | T5 | T6 | T7 |
|---|---|---|---|---|---|---|---|---|
| S100 | 1 | ACK | 1 | 0 | 0 | X | X | 0 |
| S200 | 1 | ACK | 0 | 1 | 0 | X | X | 0 |
| S400 | 1 | ACK | 1 | 1 | 0 | X | X | 0 |
| S800 | 1 | ACK | 0 | 0 | 1 | X | X | 0 |
| S1600 | 1 | ACK | 1 | 0 | 1 | X | X | 0 |
| S3200 | 1 | ACK | 0 | 1 | 1 | X | X | 0 |

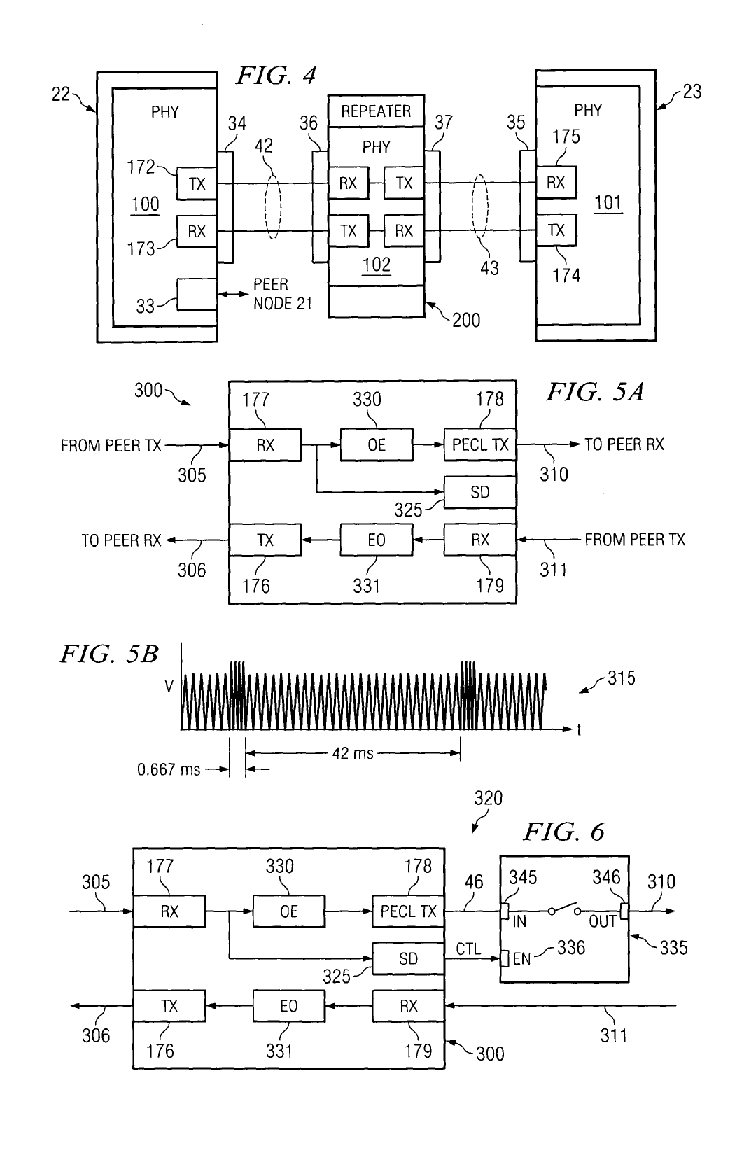

It is often necessary or desirable to locate a repeater in a serial bus system. For example, internodal distance is limited by the particular transmission medium interconnecting peer nodes. Typically, nodes interconnected with an electrical transmission medium are limited to approximately a 4.5 meter transmission distance. In such a situation, a 1394b compatible node having a PHY layer configured as a repeater is deployed to increase the distance between the peer nodes. Assume for illustrative purposes that nodes 22 and 23 are separated by a distance that exceeds the single hop transmission requirements as shown by the simplified block diagram of nodes 22 and 23 interconnected with a repeater 200 in FIG. 4. A physical connection is established between port 34 of node 22 and a port 36 of repeater 200 by transmission medium 42. Likewise, a physical connection is established between repeater 200 and node 23 by interconnection of a transmission medium 43 between a port 37 of repeater 200 and port 35 of node 23. In general, repeater 200 comprises a PHY layer 102 and data received at one port, e.g., port 36, is transmitted out another port, e.g., port 37. Repeater 200 is assigned a bus address during bus initialization and is counted as a node hop by the bus management system when data transactions pass therethrough.

The present invention provides a fiber optic transceiver that may be implemented as a repeater node of a serial bus system such that the repeater does not require a bus address or consume a node hop. With reference to FIG. 5A, there is shown a block diagram of a fiber optic transceiver 300 that may be implemented as a repeater in a serial bus system in accordance with embodiments of the invention. Transceiver 300 receives optic signals over a fiber optic link 305 interconnected with an optic RX 177 that is coupled with an optic-to-electrical conversion (OE) circuit 330. OE circuit 330 converts the optic signal to a corresponding electrical signal and drives an emitter coupled logic (ECL) transmitter, e.g., a positive-referenced ECL (PECL) TX 178 circuit, for transmission of the electrical signal over an electrical transmission medium 310. An electrical signal received over an electrical transmission medium 311 is converted to a corresponding optic signal by an electrical-to-optic conversion circuit (EO) 331 coupled with an electrical RX 179 and an optic TX 176 for transmission of the optic signal over optic transmission medium 306.

PECL TX 178 produces electrical signals corresponding to the optic signal received over transmission medium 305 for output over transmission medium 310. A typical PECL TX 178 is operable to generate electrical signals of bit frequencies of approximately 20 ns. While PECL TX 178 is well suited for high speed data links, the low-output impedance of PECL TX 178 often results in high-frequency noise output as is well known. Implementation of fiber optic transceiver 300 as a repeater for use in a 1394b cable bus environment is thus problematic. For example, connection detection management in a 1394b cable bus environment relies on a signal detect circuit being able to distinguish a connection tone signal from intervening signal silence as described above. However, high frequency noise output by PECL TX 178 renders the connection tones unrecognizable to a signal detect circuit. Similarly, a speed negotiation code comprises a pattern of signal tones with intervening silence between adjacent tones of the speed code pattern. High frequency PECL noise output by PECL TX 178 can distort a connection detect tone and a speed negotiation tone pattern such that a successful node connection and speed negotiation is not possible between nodes connected with intervening transceiver 300. FIG. 5B is an illustrative voltage waveform 315 output by PECL TX 178 when transceiver 300 is supplied with connection tone sequence 165 at RX 177. The connection tones are converted to a corresponding electrical signal and are applied to electrical transmission medium 310. However, PECL TX 178 output is characterized by high-frequency PECL noise that distorts the connection tone to the extent that the tone is indistinguishable by signal detect circuit 168 and 169 from PECL noise.

In a preferred embodiment, a switching mechanism for decoupling PECL TX 178 from a peer node during periods when no optic input signal is being received by receiver 177 is provided. Thus, signal silence is properly detected by a receiving node and connection and speed code tones may be properly evaluated. FIG. 6 is a simplified schematic of fiber optic transceiver 300 as implemented in a repeater node 320 in accordance with embodiments of the invention. Fiber optic transceiver 300 comprises RX 177, or an optic input interface, adapted to receive an optic signal supplied thereto. OE circuit 330 is coupled with the optic input and converts the optic signal into a corresponding electrical signal. A signal detect circuit 325 is adapted to detect application of an optic signal input at RX 177 and generate a control signal (CTL) indicative thereof. Output of OE circuit 330 drives PECL TX 178 and output thereof is supplied to an input (IN) 345 of a switching circuit 335 by an electrical transmission medium 46. The control signal generated by signal detect circuit 325 is supplied to an enable (EN) input 336 of switching circuit 335. Switching circuit 335 comprises an output (OUT) 346 that is coupled with electrical transmission medium 310, e.g., a copper twisted pair, that provides a simplex physical link with a peer node connected therewith. Switching circuit 335 is biased into a conducting state when the control signal is asserted and is biased into a non-conducting state when the control signal is not asserted. Accordingly, PECL TX 178 is decoupled from a peer node interconnected with transmission medium 310 when the signal detect is not asserted. Thus, transceiver 300 supplies output on electrical transmission medium 310 only when the control signal is asserted, that is only when an optic signal is detected at RX 177 by signal detect circuit 325. PECL noise produced by PECL TX 178 is not received by the destination node and signaling silence can be discerned by a node coupled with transceiver 300.

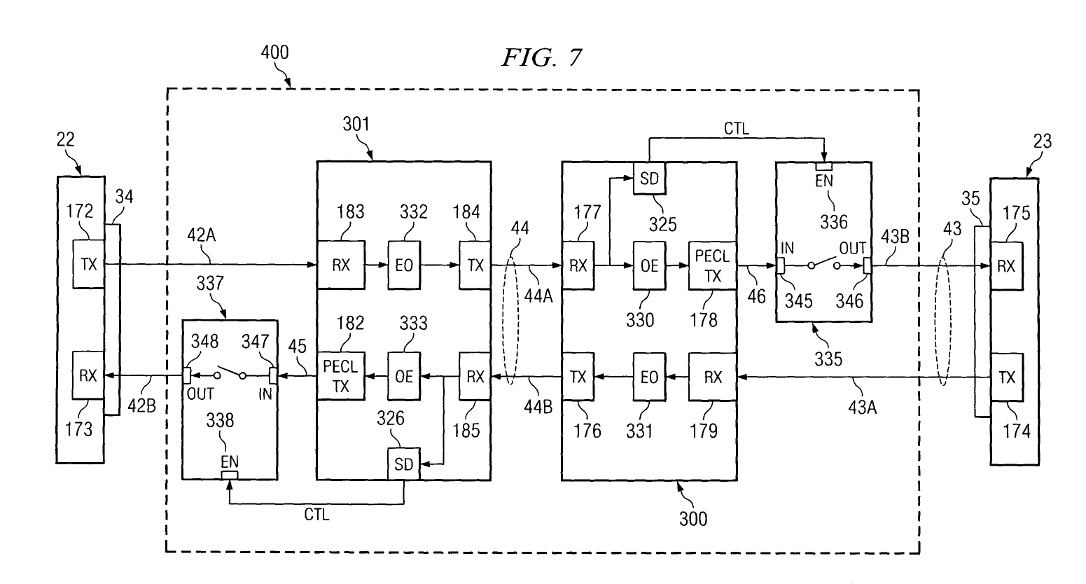

FIG. 7 is a block diagram of a repeater configuration 400 comprising two fiber optic transceivers 300 and 301 in accordance with an embodiment of the invention. In the illustrative example, an electrical RX 183 of fiber optic transceiver 301 is coupled with TX 172 of serial bus node 22 via twisted pair 42A. An electrical signal transmitted from node 22 to fiber optic transceiver 301 is conveyed to an EO circuit 332 and an optic signal corresponding thereto is output from transceiver 301 via an optic TX 184. The optic signal output by transceiver 301 is conveyed to RX 177 of fiber optic transceiver 300 via a physical link 44A of a fiber optic transmission medium 44. The fiber optic signal conveyed to RX 177 is converted to a corresponding electrical signal by OE circuit 330 and signal detect circuit 325 drives a control signal during application of an optic signal at RX 177. The electrical signal generated by OE 330 is supplied to PECL TX 178 and an emitter coupled logic electrical signal is output over an electrical transmission medium 46 and supplied to input 345 of switching circuit 335. Signal detect circuit 325 is coupled with enable input 336 of switching circuit 335. Output 346 of switching circuit 335 is interconnected with port 35 of node 23. Switching circuit 335 electrically couples PECL TX 178 with port 35 of node 23 by way of twisted pair 43B when signal detect circuit 325 drives a suitable control signal (CTL) to bias switching circuit 335 into a conducting state. In the absence of an optic signal at RX 177, switching circuit 335 is biased off and PECL TX 178 is electrically decoupled from twisted pair 43B and port 35 of node 23.

In a similar manner, an electrical signal produced at TX 174 of node 23 is conveyed to RX 179 of transceiver 300 and a corresponding optic signal is produced by EO circuit 331 and is output by TX 176. The optic output of TX 176 is conveyed to an optic RX 185 of transceiver 301 via a physical link 44B of optic transmission medium 44. An OE circuit 333 converts the optic signal received by RX 185 and drives a PECL TX 182. PECL TX 182 is coupled with an input 347 of a switching circuit 337. A signal detect circuit 326 is coupled with an enable input 338 of switching circuit 337. Signal detect circuit 326 detects the presence of an optic signal at RX 185 and drives a control signal that is supplied to enable input 338 and biases switching circuit 337 into a conducting state when the control signal is asserted. An output 348 of switching circuit 337 is coupled with port 34 of node 23. Switching circuit 337 electrically decouples PECL TX 182 from port 34 of node 22 when biased off by signal detect circuit 326 and electrically couples PECL TX 182 with port 34 when biased on by signal detect circuit 326. Accordingly, a non-addressable duplex repeater configuration is provided by transceivers 300 and 301 for establishing physical links between nodes 22 and 23 such that signaling silence is suitably detectable by nodes 22 and 23 and in a manner that does not consume a bus node address or hop.

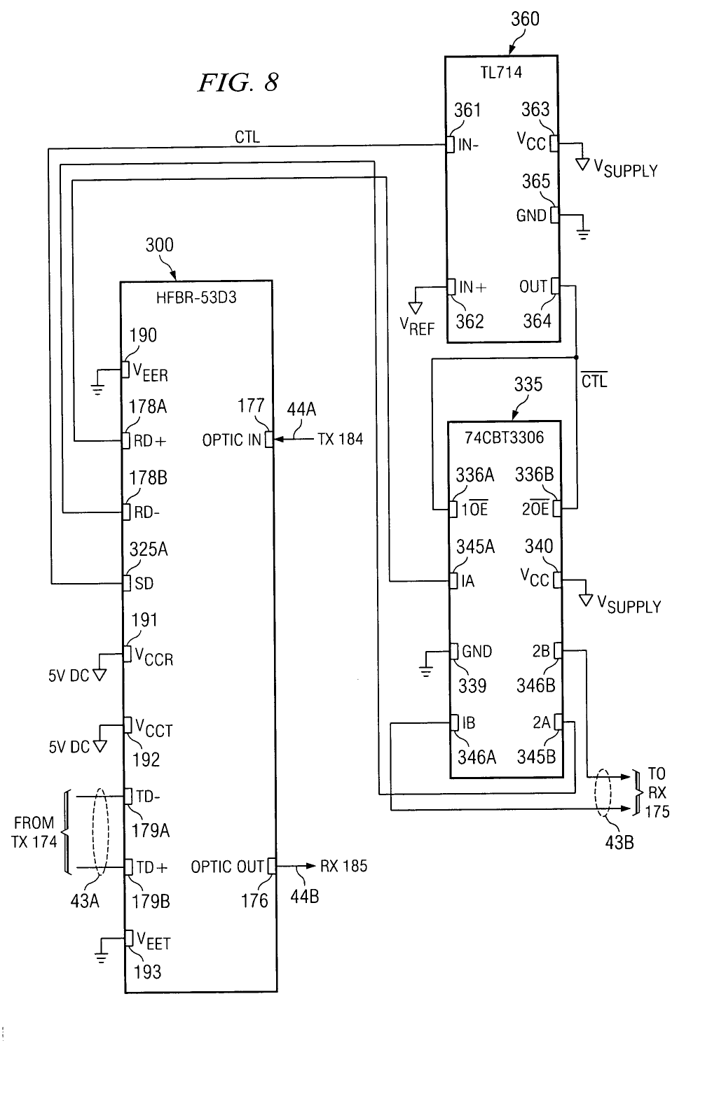

Repeater node 320 may be implemented with commonly available electronic components. In an exemplary implementation, repeater node 320 is fabricated with an optical transceiver having a part number of HFBR-53D3 manufactured by AGILENT TECHNOLOGIES and a dual field effect transistor bus switch having a part number of 74CBT3306 manufactured by TEXAS INSTRUMENTS. In the exemplary implementation, a comparator having a part number TL714 manufactured by TEXAS INSTRUMENTS is used for coupling the signal detect output of the transceiver with the enable input of the switch. FIG. 8 is an exemplary repeater node 320 as implemented in repeater configuration 400 in accordance with embodiments of the invention. Transceiver 300 is implemented with an HRBR-53D3 fiber optic transceiver. A receiver signal ground (V_{EER}) pin 190 is connected to the receiver signal ground plane. A receiver data out (RD+) pin 178A and a receiver data out bar (RD−) pin 178B are respectively connected with switch input (1A and 2A) pins 345A and 345B of switch 335. A signal detect pin 325A is connected with an inverting input (IN−) pin 361 of comparator 360. A receiver power supply (V_{CCR}) pin 191 is connected with a 5 volt DC receiver power supply filter circuit. A transmitter power supply (V_{CCT}) pin 192 is connected with a 5 volt DC transmitter power supply filter circuit. A transmitter data in bar (TD−) pin 179A and a transmitter data in (TD+) pin 179B are connected with twisted pair 43A that terminates with TX 174 of node 23. A transmitter signal ground (V_{EET}) pin 193 is connected with the transmitter signal ground plane.

The signal detect output of an HRBR-53D3 transceiver comprises an active high PECL output. A 74CBT3306 switching circuit, however, requires an active low output-enable (\overline{OE}) input. Comparator 360 is configured in an active-low configuration. Supply of the signal detect control signal (CTL) to comparator 360 functions to invert the signal detect control signal and convert the control signal from a PECL logic level to a transistor-transistor logic (TTL) level suitable for supply to switching circuit 335. Accordingly, a reference voltage (V_{REF}) is connected with a comparator input (IN+) pin 362 and is selected to be between a low and high value of the PECL voltage level. A supply voltage (V_{SUPPLY}) is connected with a supply voltage (V_{CC}) pin 363 of comparator 360. An output (OUT) pin 364 of comparator 360 is connected with active low switch output-enable (1\overline{OE} and 2\overline{OE}) input pins 336A and 336B. Comparator 360 is grounded at ground (GRD) pin 365.

Switch output (1B and 2B) pins 346A and 346B are connected with twisted pair 43B that terminates at RX 175 of port 35. Accordingly, when an optic signal is detected at optic receiver 177 of transceiver 300, an active high control signal (CTL) is output at SD pin 325A and is supplied to input pin 361 of comparator 360. An asserted CTL signal is at a higher voltage level than the comparator reference voltage V_{REF}. Accordingly, an inverted control signal \overline{CTL} comprising a TTL low voltage is applied to output-enable input pins 336A and 336B and switching circuit 335 is biased into a conducting state. Thus, data out pins 178A and 178B are electrically coupled with switch output pins 346A and 346B. When no optic signal is detected at optic receiver 177, control signal CTL is at a PECL-low voltage level and is applied to comparator input pin 361. The PECL-low voltage level is less than the comparator reference voltage V_{REF} and the inverted control signal CTL comprises a TTL high voltage. The TTL-high level voltage is applied to output-enable input pins 336A and 336B and switching circuit 335 is biased into a non-conducting state. Accordingly, data out pins 178A and 178B are electrically decoupled from switch output pins 346A and 346B in the absence of an optic signal at optic receiver 177. Transceiver 301 and switching circuit 337 may be implemented in a similar manner and configured with transceiver 300 and switching circuit 335 for fabrication of the repeater configuration 400 described above with reference to FIG. 7.

The repeater configuration illustrated in FIG. 7 may find particular application in bus prototyping environments when the prototyping environment does not facilitate accurate modeling of the physical environment on which a design bus is to be deployed. For example, an aircraft electronics system may be deployed on a 1394b cable bus comprised only of copper or other electrical transmission medium and is confined to small routing areas limited by the dimensions of an aircraft fuselage infrastructure. However, prototyping and troubleshooting of the bus design may be carried out in one or more laboratories where accurate reproduction of the fuselage confinement is not possible. One or more repeaters as described above may be implemented to accurately prototype a design bus such that hop counts and node address assignments are accurately modeled while the prototype spans a larger transmission distance than what is possible by the design bus to be deployed within the aircraft. For example, system transmission mediums 40-42 of bus system 10 may each respectively comprise an electrical transmission medium. A prototype of system 10 may be designed and built that features repeater configuration 400 disposed between, for example, peer nodes corresponding to system 10 nodes 22 and 23. Node address and hop counts observed on the prototype bus will accurately reflect that obtained on system 10 because repeater configuration 400 does not feature an addressable physical layer and thus neither of transceivers 300 or 301 are assigned a bus address or consume a bus hop as monitored by the serial bus management system.

While the invention has been particularly shown and described by the foregoing detailed description, it will be understood by those skilled in the art that various changes, alterations, modifications, mutations and derivations in form and detail may be made without departing from the spirit and scope of the invention. Particularly, the invention has been shown and described with reference to the 1394b serial bus standard. However, implementations and variations of the invention may be made for any serial bus environment that relies on signaling silence for proper bus configuration or operation.

1. A repeater node for a serial bus system, comprising:
an optic receiver adapted to receive an optic signal supplied thereto;
an optic-to-electrical conversion circuit adapted to convert the optic signal into a corresponding electrical signal;
a transmitter adapted to output the electrical signal; and
a switching mechanism coupled with the transmitter and adapted to electrically decouple the transmitter from an electrical transmission medium in the absence of the optic signal.

2. The node according to claim 1, further comprising a signal detect circuit for asserting a control signal when the optic signal is supplied to the optic receiver.

3. The node according to claim 1, wherein the switching mechanism comprises an electrically switching circuit including an input and output, the switching circuit output coupled with the transmission medium, the switching circuit further comprising an enable input; and
a signal detect circuit adapted to detect the optic signal and drive a control signal to the switching circuit enable input.

4. The node according to claim 1, further comprising:
an electrical receiver adapted to receive an electrical signal supplied thereto;
an electrical-to-optic conversion circuit coupled with the electrical receiver; and
an optic transmitter coupled with the electrical-to-optic conversion circuit, the optic transmitter adapted to output an optic signal corresponding to the electrical signal supplied to the electrical receiver.

5. The node according to claim 1, wherein the transmitter comprises an emitter coupled logic circuit for producing the electrical signal, the emitter coupled logic circuit driven by the optic-to-electrical conversion circuit.

6. The node according to claim 5, wherein the emitter coupled logic circuit comprises a positive-referenced emitter coupled logic circuit.

7. The node according to claim 1, wherein the switching mechanism comprises an input and output, the transmitter coupled with the switching mechanism input, the switching mechanism output adapted to interconnect with the electrical transmission medium.

8. A cable serial bus system, comprising:
a first node comprising a physical layer and a port adapted to receive an electrical signal supplied thereto;
a first fiber optic transceiver adapted to convert an optic signal into the electrical signal, the first transceiver comprising a transmitter adapted to output the electrical signal;
a switching mechanism adapted to couple the transmitter and the port; and
a transmission medium coupling the switching mechanism and the port, the system adapted to decouple the transmitter from the port in the absence of the optic signal.

9. The system according to claim 8, wherein the transceiver comprises an optic receiver and a signal detect circuit adapted to detect the presence of the optic signal at the optic receiver.

10. The system according to claim 8, wherein the transceiver comprises a signal detect circuit operable to detect the optic signal and adapted to bias the switching mechanism into a conducting state upon detection of the optic signal, the signal detect circuit further adapted to bias the switching mechanism into a non-conducting state when an absence of the optic signal is detected.

11. The system according to claim 8, wherein the transmitter comprises an emitter-coupled logic transmitter adapted to produce the electrical signal.

12. The system according to claim 8, wherein the transmission medium provides a simplex physical link for signal transmission from the switching mechanism to the first node.

13. The system according to claim 8, wherein the transmission medium comprises a copper twisted pair.

14. The system according to claim 8, wherein the first fiber optic transceiver comprises an optic receiver adapted to receive the optic signal, the system further comprising:
a second node comprising a physical layer and a port adapted to transmit an electrical signal therefrom; and
a second fiber optic transceiver coupled with the port of the second node and the optic receiver of the first transceiver, the second transceiver adapted to convert the electrical signal transmitted from the second node into the optic signal and supply the optic signal to the optic receiver of the first transceiver.

15. The system according to claim 14, further comprising an electrical transmission medium coupling the second node and the second transceiver.

16. The system according to claim 14, further comprising a fiber optic transmission medium coupling an optic transmitter of the second transceiver with the optic receiver of the first transceiver.

17. The system according to claim 14, wherein the first and second nodes are operable to negotiate a transmission speed for data transmissions therebetween.

18. The system according to claim 8, wherein the first transceiver comprises a signal detect circuit, the system further comprising a comparator having an input coupled with the signal detect circuit and an output coupled with an enable input of the switching mechanism.

19. The system according to claim 8, wherein the first node is adapted to operate at one of a plurality of data rates.

20. The system according to claim 19, wherein the electrical signal comprises a plurality of tones of a constant frequency respectively separated by a signal silence interval.
